(19) United States
(12) Patent Application Publication
(10) Pub. No.: US 2006/0040082 A1
(43) Pub. Date: Feb. 23, 2006

(54) Disposable body warmer and method of producing the same

(76) Inventor: Kunihiro Tabuchi, Mitoyo-gun (JP)

Correspondence Address: JORDAN AND HAMBURG LLP, 122 EAST 42ND STREET, SUITE 4000, NEW YORK, NY, 10168, US

(21) Appl. No.: 11/054,909

(22) Filed: Feb. 10, 2005

(30) Foreign Application Priority Data
Aug. 18, 2004 (JP) 2004-238489

(51) Int. Cl. B32B 33/00; B32B 3/10

(52) U.S. Cl. 428/40.1; 428/137; 428/76

(57) ABSTRACT

An exothermic composition powder is sealed in a bag body of synthetic resin film having a top sheet pierced to form a number of vent holes, and the inside of the top sheet is provided with a leakage preventive sheet for preventing leakage of the exothermic composition powder through the vent holes. A closing sheet for closing the vent holes is releasable stuck to the outside of the air-permeable sheet. The bag body comprises the top sheet and a back sheet having airtightness, and the region of the top sheet excluding the peripheral edge thereof is formed with a number of said vent holes in the form of fine holes or small holes. This makes it possible to provide easy and inexpensive production, to prevent leakage of the exothermic composition powder inside the bag body, and to dispense with the conventional sealing bag.

### BACKGROUND OF THE INVENTION AND RELATED TECHNOLOGY

A disposable body warmer is arranged such that in a bag body consisting of a top sheet having air-permeability and a back sheet having airtightness is sealed an exothermic composition powder consisting mainly of oxidizable metal powder, such as iron powder or aluminum powder. Usually, the exothermic composition powder is put in a sealed bag having airtightness so as not to contact air. In use, the sealed bag is unsealed to allow the exothermic composition powder to contact oxygen in the air so as to generate heat.

A bag body commonly used for this disposable body warmer has heretofore employed a bag body using a non-woven fabric as the top sheet and a synthetic resin film as the back sheet (Patent document 1: Japanese Utility Model Laid-Open Hei 6-7720). Further, recently, some bag bodies have used, instead of non-woven fabric, a synthetic resin film to form a top sheet, which synthetic resin film is formed with a number of vent holes in the form of fine holes or small holes, (known example).

Further, a disposable body warmer using a bag body has been proposed, the bag body constituting the top sheet by using an air-permeable sheet, such as a non-woven fabric and the back sheet by using a air-impermeable sheet, the top sheet being fused at high temperature to seal sections around the outer peripheries of both sheets to form a barrier section, with an air-impermeable release sheet stuck to the entire outer surface of the air-permeable sheet (Patent Document 2: Japanese Utility Model Laid-Open 2002-360624).

In the prior art Patent Document 1, there are drawbacks that a sealed bag is required for sealing a disposable body warmer therein, that a non-woven fabric, which is expensive as compared with a synthetic resin film, is used for the top sheet, and that bonding between the non-woven fabric for the top sheet and the synthetic resin film for the back sheet is hard to effect, these drawbacks leading to a drawback that the cost for production of a disposable body warmer becomes high. On the other hand, in the case of the known example, despite the need for a sealed bag, a synthetic resin film is used instead of a non-woven fabric to form a top sheet; thus, since both the top sheet and the back sheet are made of synthetic resin film, the production cost can be greatly reduced and so can the price of a disposable body warmer.

In the case of the known example, however, since use is made of a bag body in which the synthetic resin film constituting the top sheet is formed with a number of vent holes in the form of fine holes or small holes, with an exothermic composition powder put directly in the bag body, there is a danger of the exothermic composition powder in the bag body leaking out through the vent holes to soil clothes or the like when an external force is applied to the bag body during use.

In contrast, in the Patent Document 2, since an air-permeable sheet, such as non-woven fabric is used to constitute the top sheet, leakage of the exothermic composition powder in the interior can be prevented, so that problems, such as the soiling of clothes or the like due to such leakage, do not occur. This also holds true with Patent Document 1.

In the case of Patent Document 2, however, despite the fact that the air-permeable sheet constituting the top sheet is fused at high temperature to the seal sections around the outer peripheries of the top sheet and back sheet, so as to form a barrier section, while the release sheet in the form of an air-impermeable sheet is stuck to the entire surface outside the top sheet, thereby dispensing with a sealed bag used to seal a disposable body warmer therein, the bag body is poor in sealability, posing a problem of the exothermic composition powder being deteriorated during storage before use.

That is, in the past, there has been employed a method in which a multi-layer sheet of non-woven fabric and air-permeable porous PE film is used as a top sheet, with a low melting point chemical fiber used for the non-woven fabric, and in the sealing process in the production line, the non-woven fabric is heated to a high temperature to fuse the fiber by the pressing and heating actions of a pair of sealing rollers, thereby forming a barrier section.

Despite the use of a low melting point chemical fiber for the non-woven fabric, however, it is very difficult to reliably fuse the traveling top sheet in a very short time in a sealing step for a production line. Therefore, if a fusion defect occurs to the top sheet, even if a release sheet is present to cover the entire surface outside the top sheet, air enters into the bag body form the end surface of the non-woven fabric constituting the top sheet via the defective barrier portion of the non-woven fabric and pore portions of the porous PE film. And, if this continues for a long period of time, the exothermic composition powder gradually deteriorates.

### OBJECTS AND SUMMARY OF THE INVENTION

With such prior art problems in mind, an object of the invention is to provide a disposable body warmer which can be produced at low cost, easily and inexpensively and which prevents leakage of exothermic composition powder in a bag body and makes it possible to dispense with a conventional sealed bag, and the invention also provides a method of producing the same.

The invention provides a disposable body warmer in which in a bag body 4 of synthetic resin film whose at least one surface has an air-permeable sheet 2 formed with a number of vent holes 6 is sealed an exothermic composition powder 5, wherein a leakage preventive sheet 7 is installed on the inside of said air-permeable sheet 2 to prevent leakage of said exothermic composition powder 5 from said vent holes 6.

A closing sheet 8 for closing said vent holes 6 may be releasably stuck to the region outside said air-permeable sheet 2. Further, said bag body 4 may comprise a top sheet 2 constituting said air-permeable sheet, and a back sheet 3 having airtightness, the area of said top sheet 2 excluding its peripheral edge may be formed with a number of said vent holes 6 in the form of fine holes or small holes, and said leakage preventive sheet 7 may be installed on the inside of said top sheet 2. In addition, the top sheet 2 may have piercing applied to the vicinity of its outer edge to form vent holes 6, and the holes in the vicinity of the outer edge may be closed at the time of sealing by the seal sections 11. In this case also, the vent holes 6 are distributed in the region of the top sheet 2 excluding the seal sections 11 around the peripheral edge. Said back sheet 3 may be provided with an adhesive layer 9 for adhesion to clothes or the like and with a release sheet 10 which protects said adhesive layer 9.

Further, the invention provides a method of producing a disposable body warmer 1 wherein an exothermic composition powder 5 is sealed in a bag body 4 made of synthetic resin film provided with a top sheet 2 having vent holes 6 and a back sheet 3 having airtightness, and a leakage preventive sheet 7 for preventing leakage of said exothermic composition powder 5 from said vent holes 6 is stuck to the inner surface of said top sheet 2, said method comprising a step 31 for cutting a leakage preventive sheet material 29 into unit lengths, a step 32 for sticking the leakage preventive sheet 7 of unit length to the inner surface of the top sheet material 21 pierced to have a number of vent holes 6, a step 35 for interposing an exothermic composition powder 5 between said top sheet material 21 and the back sheet material 34 in a region corresponding to said leakage preventive sheet 7, and a step 36 for sealing said top sheet 2 and said back sheet 3 around the outer peripheries of the leakage preventive sheet 7 and exothermic composition powder 5. The method may include a step 22 for piercing said top sheet material 21 to provide said vent holes 6, and a step 32 for sticking said leakage preventive sheet 7 to the inner surface of said top sheet material 21 in a region corresponding to the region of formation of the vent holes 6. The method may include a step 26 for cutting a closing sheet material 24 into unit lengths, and a step 27 for sticking the closing sheets 8 of unit length to the outer surface of said top sheet material 21 in regions each corresponding the region of formation of the vent holes 6.

In the invention, the special quality of the bag body 4 of synthetic resin film is effectively utilized to dispense with the conventional sealing bag. Waste of material can be prevented, and there is no need for the troublesome operation of putting disposable body warmers one by one into sealing bags. Production is easy and inexpensive. And the operating efficiency in producing disposable body warmers can be greatly improved.

### BRIEF DESCRIPTION OF THE DRAWINGS

FIG. 1 is a perspective view of a disposable body warmer, showing a first embodiment of the invention;

FIG. 2 is a sectional view of the disposable body warmer, showing the first embodiment of the invention;

FIG. 3 is an exploded perspective view of the disposable body warmer, showing the first embodiment of the invention;

FIG. 4 is an exploded perspective view of the disposable body warmer, showing the first embodiment of the invention;

FIG. 5 is an explanatory view of the disposable body warmer, showing the first embodiment of the invention;

FIG. 6 is an explanatory view of the disposable body warmer, showing the first embodiment of the invention;

FIG. 7 is a production process diagram, showing the first embodiment of the invention;

FIG. 8 is a schematic view of a production apparatus, showing the first embodiment of the invention;

FIG. 9 is a perspective view of the principal portion of the production apparatus, showing the first embodiment of the invention;

FIG. 10 is a perspective view of the principal portion of the production apparatus, showing the first embodiment of the invention;

FIG. 11 is an explanatory view of an application pattern of a hot melt adhesive agent, showing the first embodiment of the invention;

FIG. 12 is an explanatory view of an application pattern of a hot melt adhesive agent, showing the first embodiment of the invention;

FIG. 13 is a perspective view of a disposable body warmer, showing a first embodiment of the invention;

FIG. 14 is a perspective view of a disposable body warmer, showing a second embodiment of the invention;

FIG. 15 is a perspective view of a disposable body warmer, showing a third embodiment of the invention;

FIG. 16 is a sectional view of a disposable body warmer, showing the third embodiment of the invention; and

FIG. 17 is a sectional view of a disposable body warmer, showing the third embodiment of the invention.

### DETAILED DESCRIPTION OF THE PREFERRED EMBODIMENTS OF THE INVENTION

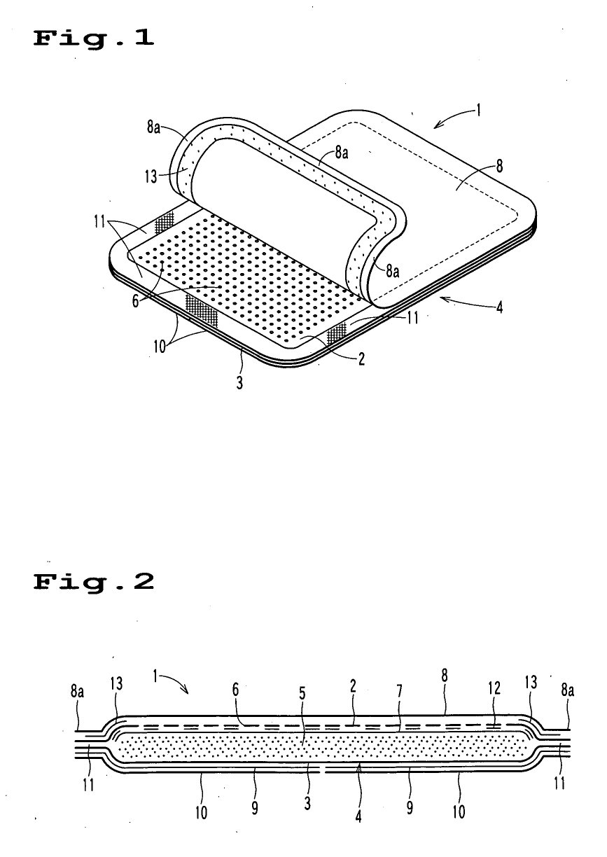

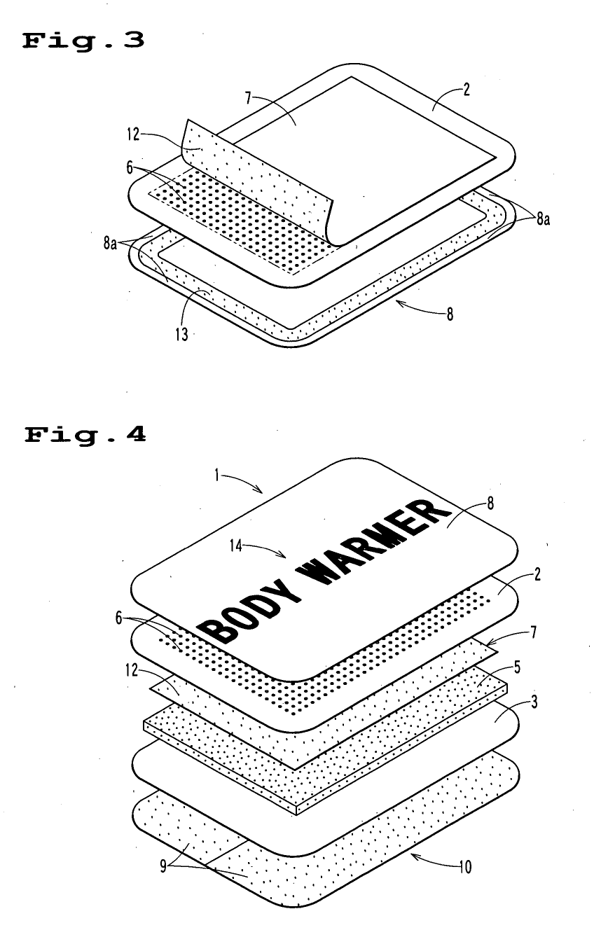

Embodiments of the invention will now be described in detail with reference to the drawings. FIGS. 1 through 6 show a first embodiment of the invention. This disposable body warmer 1 is of the sticking type, and as shown in FIGS. 1 through 4, it comprises a bag body 4 having a top sheet 2 and a back sheet 3, an exothermic composition powder, 5 sealed in this bag body 4, a leakage preventive sheet 7 installed on the inside of the top sheet 2 and adapted to prevent leakage of the exothermic composition powder 5 through the vent holes 6, a closing sheet 8 releasably stuck to the top sheet 2 and adapted to close the vent holes 6, an adhesive layer 9 applied to the outer surface of the back sheet 3 for adhesion to clothes or the like, and a release sheet 10 protecting the adhesive layer 9.

The bag body 4 is made of synthetic resin film, prepared by superposing the top sheet 2 and back sheet 3 are superposed, each consisting of one or more synthetic resin films having airtightness, and sealing the entire peripheries of the regions outside the exothermic composition powder 5 and outside the leakage preventive sheet 7, along the seal sections 11, and is formed in a predetermined shape, such as a rectangular or band-like shape, according to the applications of the disposable body warmer 1 itself.

The inside portion of the top sheet 2 excluding the peripheral seal sections 11 is pierced so that a number of vent holes 6 the form of fine holes or small holes are substantially uniformly distributed. Therefore, the bag body 4 is composed of the top sheet 2 formed with vent holes 6 by piercing to provide air-permeability and the back sheet 3 having airtightness and is peripherally sealed along the seal sections 11.

In addition, the top sheet 2 may be pierced in a region between two sides on opposed sides (longitudinal opposite sides) over the entire length to provide vent holes 6, the holes in the opposite ends being closed by the seal sections 11 in the associated portions during sealing. This case also results in the vent holes 6 being distributed in the region of the top sheet 2 excluding the seal sections 11 in the peripheral edge.

The exothermic composition powder 5 is a powder which generates heat in an oxidation reaction for combination with oxygen in the air. For example, use is made of a mixture of an oxidizable metal powder, such as iron powder or aluminum powder, active carbon, and a water retaining agent, in predetermined proportions. And, the exothermic composition powder 5 is sealed in the bag body 4 so tat the disposable body warmer 1 is flat in its entirety.

The leakage preventive sheet 7 has air-permeability, made of an air-permeable sheet, such as tissue (e.g., tissue paper) or non-woven fabric, and capable of preventing passage of the exothermic composition powder 5 therethrough, and is interposed between the top sheet 2 and the exothermic composition powder and stuck to the inner surface of the top sheet 2 as by a hot melt adhesive agent 12 in a region corresponding to the region of formation of the vent holes 6, thereby covering all vent holes 6 in the top sheet 2 from inside. In addition, the seal sections 11 are located around the outer periphery outside the leakage preventive sheet 7 and the exothermic composition powder 5, and the top sheet 2 and back sheet 3 are sealed outside the leakage preventive sheet 7 and exothermic composition powder 5.

The closing sheet 8, which is a so-called label in a rectangular or other shape corresponding to that of the bag body 4, is constituted of a synthetic resin film or the like having airtightness and is releasably stuck or bonded to the top sheet 2 through an easy-release allowing adhesive agent, such as a hot melt adhesive agent 13, applied to one surface of the closing sheet 8. The hot melt adhesive agent 13 serving as an easy-release allowing adhesive agent is peripherally continuously applied to a region substantially corresponding to the seal sections 11 in such a manner as to surround the region of formation of the vent holes 6 with said adhesive agent 13 applied to the entire outer periphery or applied in such a manner as to leave part of said periphery unapplied, so that when the closing sheet 8 is easily releasably stuck to the top sheet 2, it seals the vent holes 6. In addition, it is only necessary for the hot melt adhesive agent 13 to close the vent holes 6; it may be applied, for example, to the entire surface of the region of formation of the vent holes 6.

The unapplied portion of the closing sheet 8 serves as a pickup section 8a used for picking up the closing sheet 8 when the latter is to be released. The pickup section 8a is disposed in the whole or part of the outer periphery. In addition, the easy-release allowing adhesive agent 13 may be applied to substantially all surface of the closing sheet 8 while leaving part of each pickup section 8a unapplied so as to form such pickup sections 8a at the corners of the closing sheet 8.

The back sheet 3 is formed with an adhesive layer 9 by an adhesive agent for sticking to a suitable place on clothes or the like when the disposable body warmer 1 is used, and the adhesive layer 9 is protected by the release sheet 10. The adhesive layer 9 is in the form of two bands extending widthwise of the back sheet 3, and two release sheets 10 are stuck to the two adhesive layers 9. In addition, the adhesive layer 9 may be disposed on the entire surface of the back sheet 3, and may be in the form of a number of strips or some bands. Further, the adhesive layer 9 may be in the form of dots of predetermined size substantially uniformly distributed over substantially the entire surface of the back sheet 3. A single release sheet 10 will be sufficient.

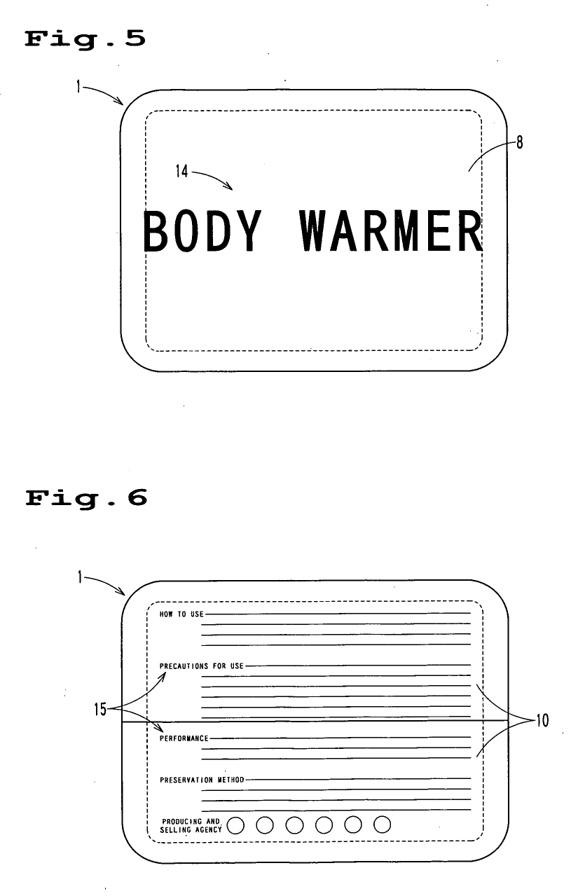

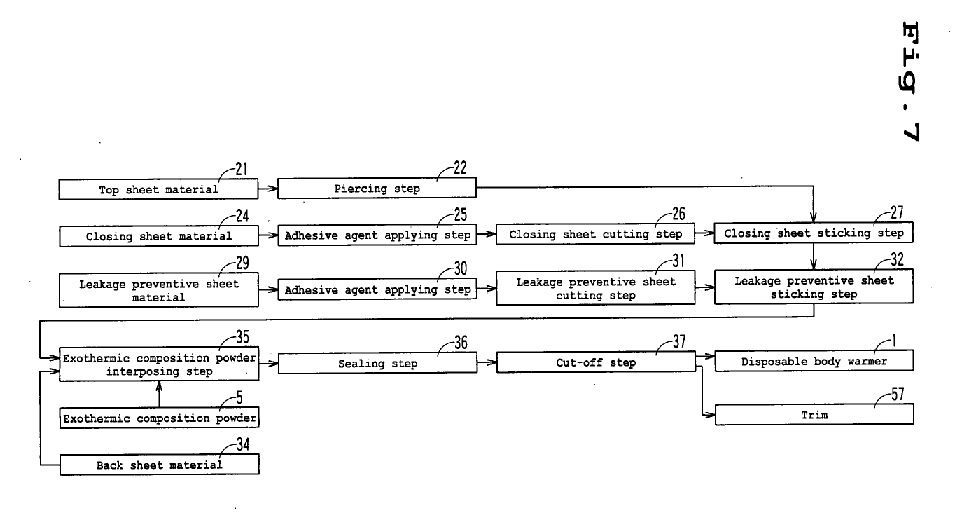

The front surface of the closing sheet 8, as shown in FIG. 5, has the trade name, a commodity design or other advertisement information (necessary information on the front side) 14 displayed thereon by printing, and the front surface of the release sheet 10, as shown in FIG. 6, has a precautionary note or other precautionary information for use (necessary information on the back side) 15 displayed thereon by printing. In addition, if the closing sheet 8 is a transparent film, it is possible to print information on the top sheet 2, and if the release sheet 10 is a transparent film, it is possible to print information on the back sheet 3.

The disposable body warmer 1 of this embodiment is arranged such that in production, after the seal sections 11 have been sealed, the top sheet 2, back sheet 3, closing sheet 8, and release sheet 10 are simultaneously cut off so that their outer peripheries substantially coincide with each other. However, if the closing sheet 8 is capable of sealing the vent holes 6, there is no need for it to be rectangular corresponding to the shape of the top sheet 2 of the back body 4, and the closing sheet 8 may be smaller in size than the top sheet 2 and may be constituted of a sheet material thicker than the bag body 4, particularly the top sheet 2.

Such disposable body warmer 1 has the following advantages. That is, the exothermic composition powder 5 is sealed in the bag body 4 of synthetic resin film which is constituted of the top sheet 2 having the vent holes 6 and the back sheet 3 having air-permeability and the closing sheet 8 is releasably stuck to the outside of the top sheet 2 in such a manner as to close the vent holes 6. And, in use, the closing sheet 8 is released from the top sheet 2 to open the vent holes 6 in the top sheet 2 for ventilation and the release sheet 10 is released for sticking to a sticking region of clothes or the like through the adhesive layer 9.

Therefore, the conventional sealing bag for closingly packaging the disposable body warmer 1 becomes unnecessary, thus avoiding waste of material, eliminating the troublesome operation of putting disposable body warmers one by one in sealing bags, a fact which, coupled with the use of a synthetic resin film which is low in material cost, makes it possible to produce the disposable body warmer 1 at low cost, easily and inexpensively.

Further, since the bag body 4 is made of synthetic resin film with a synthetic resin film used for the top sheet 2 having vent holes 6, the top sheet 2 and back sheet 3 can be reliably sealed in the seal sections 11, without problems such as the entrance of air from the end surface which occurs in the case where the top sheet 2 is made of non-woven fabric; thus, deterioration of the exothermic composition powder 5 due to entrance of air can be prevented.

Despite the fact that a number of vent holes 6 are formed, by piercing, in the top sheet 2 made of synthetic resin film, since the inside of the top sheet 2 is provided with the leakage preventive sheet 7 for prevention of leakage of the exothermic composition powder 5 from the vent holes 6, the soiling of clothes due to leakage of the exothermic composition powder 5 can be prevented. Further, using tissue or non-woven fabric for the leakage preventive sheet 7 makes it easier to embody the invention.

In the case of absence of the leakage preventive sheet 7, it is necessary to form the vent holes 6 in the top sheet 2 in such a size as to make it as difficult as possible for the exothermic composition powder 5 to leak, whereas prevention of leakage of the exothermic composition powder 5 by the leakage preventive sheet 7 makes it only necessary to form the vent holes 6 in consideration of the heating characteristics of the exothermic composition powder 5; thus, the size and the number of vent holes 6 can be easily determined.

Furthermore, since the leakage preventive sheet 7 is stuck to the inner surface of the top sheet 2 in a region corresponding to the region of formation of the vent holes 6, there is no possibility of the leakage preventive sheet 7 being moved or deviated to one side within the bag body 4; thus, the leakage preventive sheet 7 reliably prevents leakage of exothermic composition powder 5, having its quality and reliability improved. Further, in the case where tissue or non-woven fabric is used for the leakage preventive sheet 7 and the latter is stuck to the inner surface of the top sheet 2, the leakage preventive sheet 7 keeps movement, such as deviation to one side, of the exothermic composition powder 5 within the bag body 4 to a minimum.

In the case of an adhesion type disposable body warmer 1 also, since movement and deviation to one side of the exothermic composition powder 5 can be prevented by the leakage preventive sheet 7, it is possible to use the bag body 4 using one or more synthetic resin films for the top sheet 2 and back sheet 3.

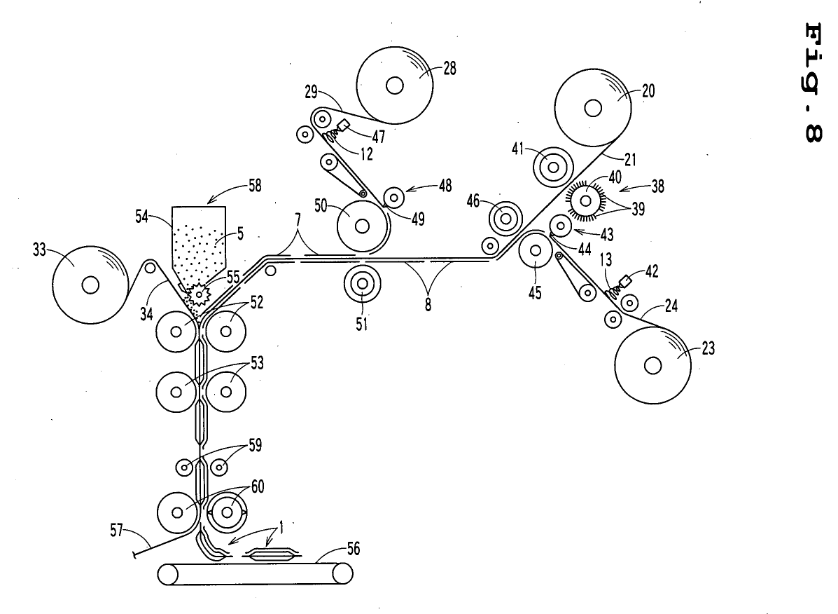

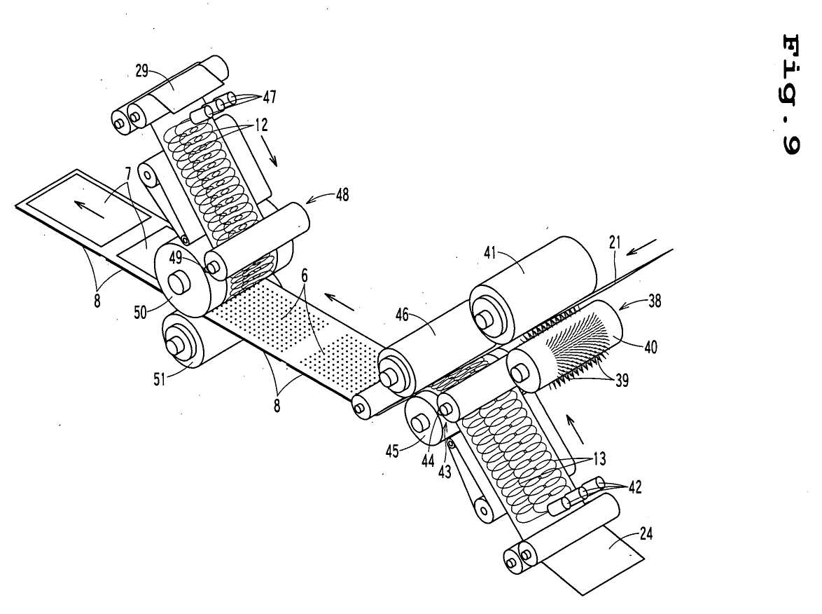

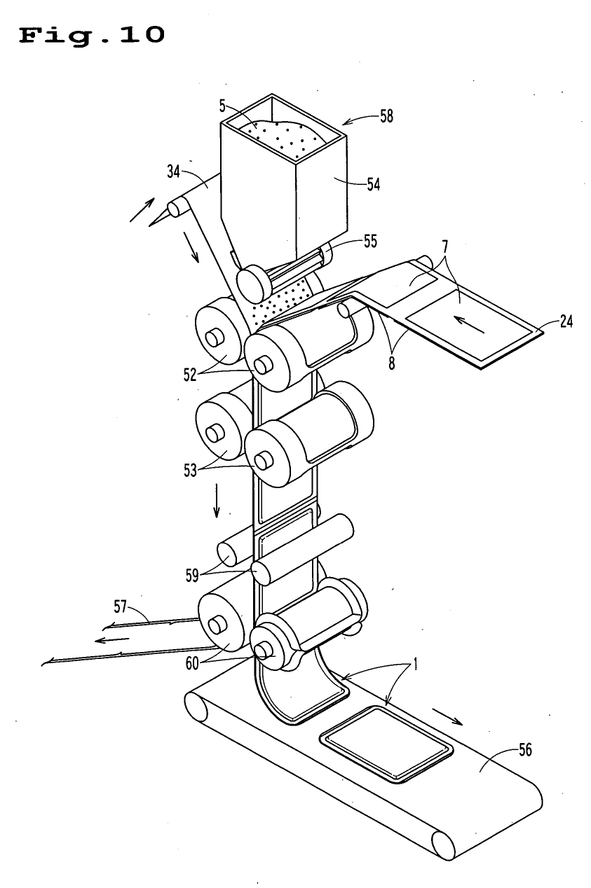

FIG. 7 shows a method of producing a non-adhesion type disposable body warmer 1, and FIG. 8 shows outlines of a production apparatus therefor. The production process for the disposable body warmer 1 comprises, as shown in FIGS. 7 and 8, a piercing step 22 for intermittently forming a number of vent holes 6 in the band-like top sheet material 21 paid out of a top sheet material raw-fabric roll 20, in regions corresponding to the regions of formation of the disposable body warmer 1, an adhesive agent applying step 25 for applying a hot melt adhesive agent 13 to a band-like closing sheet material 24 paid out of a closing sheet material raw-fabric roll 23, a closing sheet cutting step 26 for cutting the closing sheet material 24 having the hot melt adhesive agent 13 applied thereto, into unit lengths each equal to the length of the disposable body warmer 1, a closing sheet sticking step 27 for sticking the closing sheets 8 after being cut, to the outer surface of the top sheet material 21, in regions corresponding to the regions of formation of the vent holes 6, an adhesive agent applying step 30 for applying a hot melt adhesive agent 12 to a band-like leakage preventive sheet material 29 paid out of a leakage preventive sheet material raw-fabric roll 28, a leakage preventive sheet cutting step 31 for cutting the leakage preventive sheet material 29 having the hot melt adhesive agent 12 applied thereto, into unit lengths each equal to the length of the disposable body warmer 1, a leakage preventive sheet sticking step 32 for sticking the leakage preventive sheets 29 after being cut, to the inner surface of the top sheet material 21, in regions corresponding to the regions of formation of the vent holes 6, an exothermic composition powder interposing step 35 for interposing the exothermic composition powder 5 between the top sheet material 21 having the closing sheet 8 and the leakage preventive sheets 7 stuck to the inner and outer surfaces thereof, respectively, in regions corresponding to the regions of formation of the vent holes 6, and the band-like back sheet material 34 paid out of a back sheet material raw-fabric roll 33, in regions corresponding to the inside leakage preventive sheets 7, a sealing step 36 for sealing the top sheet material 21 and the back sheet material 34 after the exothermic composition powder 5 has been interposed therebetween, around the entire periphery outside the exothermic composition powder 5 and leakage preventive sheet 7, so as to form the seal sections 11, and a cut-off step 37 for cutting, after sealing, the top sheet material 21 and back sheet material 34 in the seal sections 11, so as to cut the disposable body warmers 1.

In the production of the disposable body warmer 1, using the band-like long-sized top sheet material 21 made of one or more synthetic resin films, back sheet material 34, closing sheet material 24, and leakage preventive sheet material 29, it is produced by the following procedure. First, the top sheet material 21 is paid out of the top sheet material raw-fabric roll 20, and is intermittently pierced to form a number of vent holes 6 in regions corresponding to the regions of formation of the disposable body warmer 1 by the piercing means 38 in the piercing step 22.

The piercing means 38 comprises a forming roll 40 having a number of forming needles 39 set in the outer peripheral surface thereof, and a backing roll 41 for backing the top sheet material 21, the arrangement being such that passing the top sheet material 21 between the two rolls results in a number of vent holes, 6 being formed therein. The backing roll 41 is formed on its outer periphery with a lining of silicone rubber or other elastic body or with a recess corresponding to the forming needles 39 of the forming roll 40. In addition, in the case where the top sheet material 21 is a heat processable material, the vent holes 6 can be neatly finished by the provision of a heater inside the forming roller 40.

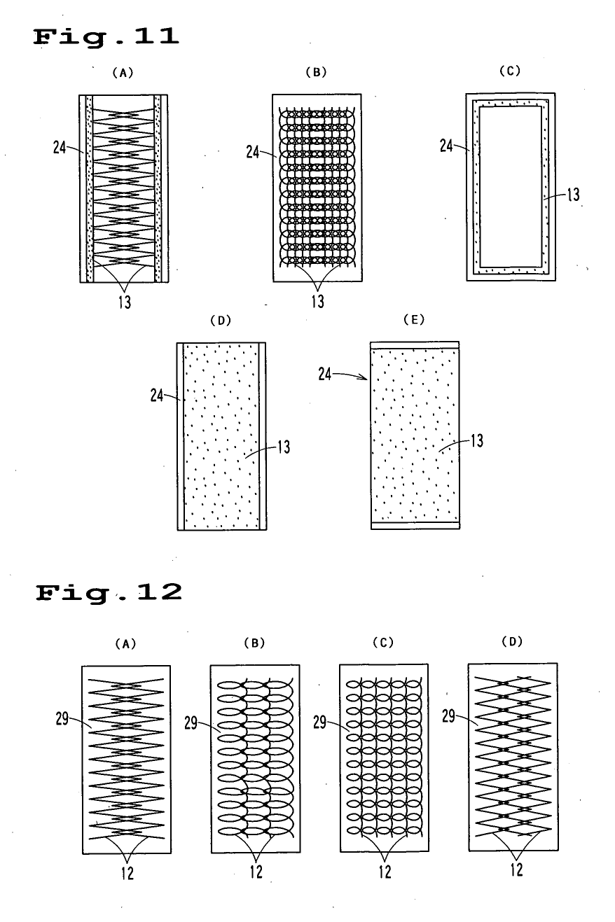

On the other hand, the closing sheet material 24 is paid out of the closing sheet material raw-fabric roll 23 and the hot melt adhesive agent 13 is applied to the outer surface of the closing sheet material 24 by the applying means 42, such as a spray nozzle in the adhesive agent applying step 25. The applying means 42 may be other than a spray nozzle. As for the coating pattern of the hot melt adhesive agent 13 in this case, there are patterns (A)-(E), shown in FIG. 11, according to the movement of the spray nozzle when it is moved relative to the closing sheet material 24.

The coating pattern (A) has longitudinal band-like coated sections formed on the widthwise opposite sides, and a zigzag streak-like coated section formed in the widthwise intermediate region. The coating pattern (B) has a plurality of longitudinal continuous spiral streak-like coated sections formed widthwise. The coating pattern (C) has a coated region continuously formed rectangularly, with the inner and outer regions left uncoated The coating pattern (D) has a coated section formed substantially throughout the surface, with longitudinal sections on the widthwise opposite sides left uncoated, and the coating pattern (E) has a section formed substantially throughout the surface, with widthwise sections on the longitudinal opposite sides left uncoated. Employing such coating patterns makes it possible to easily and reliably close the vent holes 6.

After the hot melt adhesive agent 13 has been applied, the closing sheet material 24 is successively cut by a cutting means 43 in the closing sheet cutting step 26 into unit lengths each equal to the length of the disposable body warmer 1, and the thus-cut closing sheets 8 are stuck to the outer surface of the top sheet material 21, in regions corresponding to the regions of formation of the vent holes 6, in the closing sheet sticking step 27 through the hot melt adhesive agent 13. The cutting means 43 has a rotary cutting blade 44, by which the closing sheet 24 passing between it and a sucking roll 45 is cut widthwise.

In the closing sheet sticking step 27, the top sheet material 21 is passing in a state in which it is held between the sucking roll 45 and a backing roll 46, and the closing sheets 8 cut by the cutting means 43 are sucked on to the outer peripheral surface by vacuum suction and are stuck to the outer surface of the top sheet 2, with a predetermined space left between adjacent closing sheets 8, by the sucking roll 45, which is rotating at a faster peripheral speed than the feed speed of the closing sheet material 24. In addition, the sucking roll 45 rotates at a peripheral speed which is substantially equal to the feed speed of the top sheet material 21, and rotates at substantially the same speed as the backing roll 46.

The leakage preventive sheet material 29 is paid out of the leakage preventive sheet material raw-fabric roll 28 and is coated on its inner surface with the hot melt adhesive agent 12 by a coating means 47, such as a spray nozzle, in the adhesive agent applying step 30. In addition, the width of the leakage preventive sheet material 29 is somewhat greater than that of the region of formation of the vent holes 6 in the top sheet material 21.

The coating means 47 may be other than a spray nozzle. In addition, the coating pattern of the hot melt adhesive agent 12 is the same as in the case of the hot melt adhesive agent 13 for the closing sheet material 24. In the case of the closing sheet material 24, however, it is necessary to surround the region of formation of the vent holes 6 from outside by the hot melt adhesive agent 13 applied, whereas in the case of the leakage preventive sheet material 29, it is necessary for the hot melt adhesive agent 12 not to extremely hamper the air-permeability of the vent holes 6 when the leakage preventive sheet material 29 is stuck to the top sheet material 21 through the hot melt adhesive agent 12.

Therefore, such coating patterns of the hot melt adhesive agent 12, e.g., as those shown at (A)-(D) in FIG. 12 are suitable. Employing such coating patterns makes it possible to minimize the amount of use of the hot melt adhesive agent 12.

After the hot melt adhesive agent 12 has been applied, the leakage preventive sheet material 29 is successively cut into unit lengths each equal to the length of the disposable body warmer 1 by a cutting means 48 in the leakage preventive sheet cutting step 31, and the thus-cut leakage preventive sheets 7 are stuck to the inner surface of the top sheet material 21 through the hot melt adhesive agent 12, in regions corresponding to the regions of formation of the vent holes 6, in the leakage preventive sheet sticking step 32. The cutting means 48 has a rotary cutting blade 49, by which the leakage preventive sheet material 29 passing between it and a sucking roll 50 is widthwise cut.

In the leakage preventive sheet sticking step 32, the top sheet material 21 is passing in a state in which it is held between the sucking roll 50 and a backing roll 51, and the leakage preventive sheets 7 cut by the cutting means 48 are sucked to the outer peripheral surface by vacuum suction and are stuck to the inner surface of the top sheet 2 by the sucking roll 50, which rotates at a faster peripheral speed than the feed speed of the leakage preventive sheet material 29, with a predetermined space left between adjacent leakage preventive sheets 7. In addition, the sucking roll 50 rotates at a peripheral speed which is substantially equal to the feed speed of the top sheet material 21 and rotates at substantially the same speed as the backing roll 51.

In this manner, the leakage preventive sheets 7 and the closing sheets 8 are stuck to the inner and outer surfaces of the top sheet material 21, in regions where the vent holes 6 are formed, by the hot melt adhesive agents 12 and 13. In order not to cause troubles in the sealing step 36, each leakage preventive sheet 7 is positioned inwardly of the four sides, front and back and left and right, of the closing sheet 8.

In the exothermic composition powder interposing step 35, the back sheet material 34 paid out of the back sheet material raw-fabric roll 33 and the top sheet material 21 having the leakage preventive sheets 7 and the closing sheets 8 stuck thereto are guided between a pair of first seal rolls 52 from above in a V-shaped path while predetermined amounts of exothermic composition powder 5 are interposed between the top sheet material 21 and the back sheet material 34 in regions corresponding to the inside leakage preventive sheets 7 by a dispersion means 58.

The dispersion means 58 comprises a hopper 54 disposed immediately above the V-shaped region defined between the top sheet material 21 and the back sheet material 34 and containing the exothermic composition powder 5, and dispersion rollers 55 disposed in the lower opening in the hopper 54 and rotating around horizontal axes in the delivery direction, the arrangement being such that the exothermic composition powder 5 is intermittently dispersed in synchronism with the feed speed of the top sheet material 21 and the back sheet material 34, so that the exothermic composition powder 5 is packed between the top sheet material 21 and the back sheet material 34 in regions corresponding to the leakage preventive sheets 7.

The sealing step 36 has a pair of first seal rolls 52 and a pair of second seal rolls 53, arranged in series. The first seal rolls 52 and second seal rolls 53 rotate in synchronism with the feed speed of the top sheet material 21, etc., and successively heat-seal the top sheet material 21 and back sheet material 34 outside each leakage preventive sheet 7 and exothermic composition powder 5, thus forming seal sections 11 around the entire periphery outside each leakage preventive sheet 7 and exothermic composition powder 5. And, via a pair of stretch press rolls 59 and by means of a cut-off means 60, such as a pair of outer periphery cut-off rotary cutters, in the cut-off step 37, disposable body warmers 1 are successively cut off the top sheet material 21, etc., and placed on a feed conveyor 56 for delivery. Trims 57 left after the disposable body warmer 1 are cut off is collected by an unillustrated collecting means.

When the closing sheets 8 are stuck to the top sheet material 21 in the closing sheet sticking step 27, they are done so with a predetermined space left between adjacent closing sheets 8 on the top sheet material 21, so that in the cut-off step 37, adjacent disposable body warmers 1 are cut off intermediate between adjacent closing sheets 8. Therefore, the thus-cut-off disposable body warmers 1 have their length in the direction of feed of the closing sheet 8 somewhat reduced as compared with the top sheet material 21, etc.

Further, the widthwise opposite sides of the closing sheet material 24 may be cut off together with the top sheet material 21, etc., in the cut-off step 37. Alternatively, a closing sheet material 24 having a predetermined width may be used from the start so as to avoid cutting off the closing sheets 8 in the cut-off step 37. In the case of cutting off, as shown in FIG. 13 (A), the width of the closing sheet 8 is the same as that of the top sheet material 21, etc., while in the case of not cutting off, as shown in FIG. 13 (B), the width of the closing sheet 8 is made less than that of the top sheet material 21, etc., and the closing sheet 8 is disposed between the two widthwise sides of the disposable body warmer 1. In addition, the closing sheet 8 may be disposed inside the seal sections 11 so as not to overlap the seal sections 11.

Producing the disposable body warmer 1 in such steps makes it possible to produce the disposable body warmer 1 easily and inexpensively and to greatly reduce the production cost as compared with the prior art. Further, since the leakage preventive sheet material 29 is cut into unit lengths and then the latter are stuck to the top sheet material 21 with a predetermined space left between adjacent leakage preventive sheets 7, when the top sheet material 21 and back sheet material 34 are to be sealed after the exothermic composition powder 5 has been interposed, they can be reliably sealed without the leakage preventive sheet 7 forming an obstacle. In addition, the hot melt adhesive agent may be applied in advance to either the top sheet material 21 or the back sheet material 34, so that they will be stuck to each other through the hot melt adhesive agent during sealing.

Further, before sticking to the top sheet material 21, the closing sheet material 24 is cut into unit lengths, so that there is no need to cut off the closing sheet material 24 in the cut-off step 37 for the disposable body warmer 1. Further, since the closing sheets 8 are stuck to the top sheet material 21 with a predetermined space left between adjacent closing sheets 8, the top sheet material 21 can be easily fed around the bends or the like irrespective of the presence of the leakage preventive sheets 7 and the closing sheets 8 on both sides of the top sheet material 21, thus enhancing the speedup of the production line.

In addition, in the case where the top sheet material 2, back sheet material 3, and closing sheet 8 are of substantially the same size, in the production process in FIG. 7 the closing sheet cutting step 26 and the like may be removed, and the closing sheet material 24 after being coated with the hot melt adhesive agent 13 may be stuck to the outer surface of the top sheet material 21, and the disposable body warmers 1 may be cut off from the three, the top sheet material 21, back sheet material 34 and closing sheet material 24 in the cut-off step 37 after sealing.

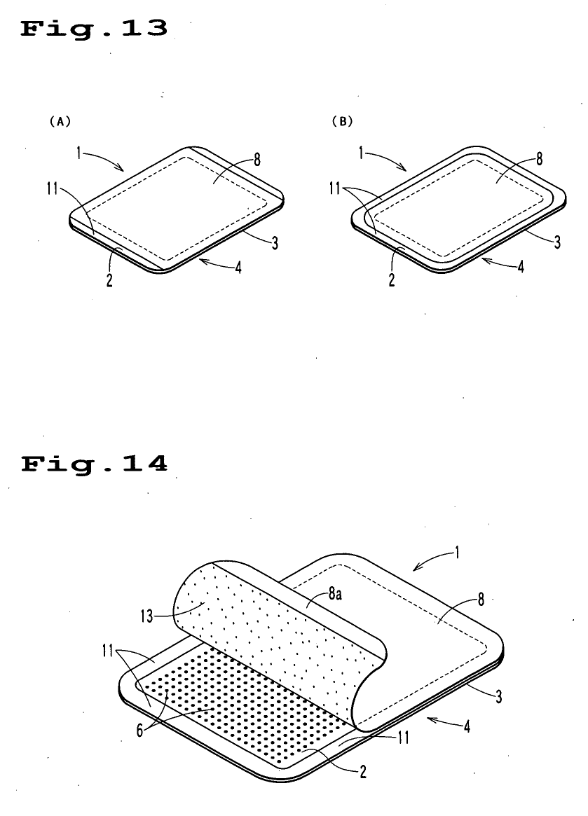

FIG. 14 shows by way of example a disposable body warmer 1 according to a second embodiment. This disposable body warmer 1 has a tab 8a, not coated with the hot melt adhesive agent 13, at one longitudinal end of the closing sheet 8. Such tab 8a may be provided anywhere in the closing sheet 8. For example, a corner of the closing sheet 8 may be a tab 8a.

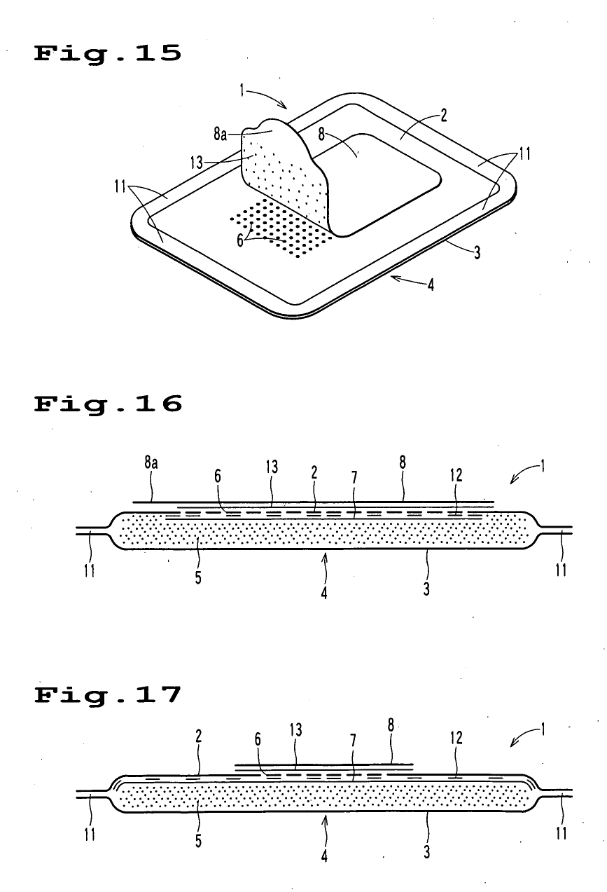

FIGS. 15 and 16 show by way of example a disposable body warmer 1 according to a third embodiment. This disposable body warmer 1 is formed with a number of vent holes 6 in the central portion of a top sheet 2 and has a band-like closing sheet 8 which is narrower than the disposable body warmer 1 stuck thereto in such a manner as to cover the region of formation of the vent holes 6. One longitudinal end of the closing sheet 8 is formed with a tab 8a. Since the exothermic composition powder 5 has air-permeability, part of such a region as the central portion of the top sheet 2 can be formed with vent holes 6 in this manner so as to reduce the size of the closing sheet 8.

In addition, it will suffice for this case, if the leakage preventive sheet 7 has a size corresponding to the that of the region of formation of the vent holes 6, and the leakage preventive sheet 7, like the closing sheet 8, can be reduced in size. However, in the case where the disposable body warmer 1 is of the stick type or the like and the leakage preventive sheet 7 also serves for prevention of movement, deviation to one side or the like of the inside exothermic composition powder 5, it is desirable, as shown in FIG. 17 to increase the size of the leakage preventive sheet 7 in a region which does not cause trouble to the sealing of the seal sections 11.

Embodiments of the invention have been described so far in detail, but the invention is not limited to these embodiments. For example, the exothermic composition powder 5 may be of a substance having physical properties other than those shown in the embodiments. The powder may be directly sealed in the bag body 4 or may be sealed in a state in which it is carried by a suitable carrying member. The leakage preventive sheet 7 is suitably made of tissue, non-woven fabric or the like, but other materials may be used. Further, the tissue or non-woven fabric may be of natural fiber or chemical fiber.

In the production of the disposable body warmer 1, use may be made of a raw-fabric of composite in which the closing sheet material 24 is easily releasably stuck in advance to the top sheet material 21 by an easy-release allowing adhesive agent, such as a hot melt adhesive agent 13, and a raw-fabric of composite in which a releasable sheet material is stuck to the back sheet material 34. Further, the bag body 4 of the disposable body warmer 1, shown by way of example, is one which is provided on one side with the top sheet 2 having vent holes 6, that is, one which is provided on one side with a air-permeable sheet having vent holes 6. However, such air-permeable sheet having vent holes 6 may be provided on each of the front and back sides.

Further, in the embodiments, the air-permeable sheet (top sheet 2) is shown by way of example in the form in which it has the closing sheet 8 for closing said vent holes 6 stuck to the outer surface thereof. However, it will suffice if the inner surface of the air-permeable sheet (top sheet 2) of the bag body 4 made of synthetic resin film is provided with the leakage preventive sheet 7. An arrangement having no closing sheet 8 for closing the vent holes 6, for example, an arrangement requiring enclosing and sealing it in a conventional sealing bag can be likewise made.

1. A disposable body warmer comprising an exothermic composition powder sealed in a bag body of synthetic resin film having at least on one surface thereof an air-permeable sheet having a number of vent holes and, in the inside of said air-permeable sheet, a leakage preventive sheet for preventing leakage of said exothermic composition powder through said vent holes.

2. A disposable body warmer as set forth in claim 1, further comprising a closing sheet for closing said vent holes releasably adhered to the outside of said air-permeable sheet.

3. A disposable body warmer as set forth in claim 2, wherein said closing sheet is stuck to the outside of said air-permeable sheet through an easy-release allowing adhesive agent applied to the entire periphery of said closing sheet or applied in such a manner as to leave part of said periphery unapplied.

4. A disposable body warmer as set forth in claim 3, wherein said easy-release allowing adhesive agent is applied in a coating pattern in which longitudinal band-like coated sections are formed on the widthwise opposite sides of said closing sheet and a zigzag streak-like coated section is formed in the widthwise intermediate region of said closing sheet.

5. A disposable body warmer as set forth in claim 3, wherein said easy-release allowing adhesive agent is applied in a coating pattern in which a plurality of spiral streak-like coated sections continuous longitudinally of said closing sheet are formed widthwise.

6. A disposable body warmer as set forth in claim 3, wherein said easy-release allowing adhesive agent is applied to said closing sheet in a coating pattern in which a coated region is continuously formed rectangularly, with the inner and outer regions left uncoated.

7. A disposable body warmer as set forth in claim 3, wherein said easy-release allowing adhesive agent is applied to said closing sheet in a coating pattern in which longitudinal or widthwise regions on the widthwise or longitudinal opposite sides are left uncoated.

8. A disposable body warmer as set forth in any of claims 1-7, wherein said bag body comprises a top sheet constituting said air-permeable sheet, and a back sheet having airtightness, the region of said top sheet excluding the peripheral edge thereof being formed with a number of said vent holes in the form of fine holes or small holes, the inside of said top sheet being provided with said leakage preventive sheet.

9. A disposable body warmer as set forth in any of claims 1-7, wherein the leakage preventive sheet is comprised of tissue or non-woven fabric in a region corresponding to the region of said vent holes.

10. A disposable body warmer as set forth in claim 9, wherein said bag body is formed such that said top sheet and said back sheet are sealed in seal sections in the peripheral edge thereof, said seal sections being disposed in the outer periphery of said leakage preventive sheet.

11. A disposable body warmer as set forth in claim 8, wherein said back sheet is provided with an adhesive layer for adhesion to clothes or the like and with a release sheet which protects said adhesive layer.

12. A method of producing a disposable body warmer, the body warmer comprising an exothermic composition powder sealed in a bag body comprised of synthetic resin film provided with a top sheet having vent holes, a back sheet having airtightness, and a leakage preventive sheet for preventing leakage of said exothermic composition powder from said vent holes, the leakage preventive sheet being stuck to the inner surface of said top sheet, said method comprising cutting a leakage preventive sheet material into unit lengths, sticking the leakage preventive sheet of unit length to the inner surface of band-like top sheet material having vent holes, interposing an exothermic composition powder between said top sheet material and back sheet material in a region corresponding to said leakage preventive sheet, and sealing said top sheet and said back sheet around the outer peripheries of the leakage preventive sheet and exothermic composition powder.

13. A method of producing a disposable body warmer as set forth in claim 12, further comprising piercing said top sheet material to provide the vent holes, and wherein said sticking of said leakage preventive sheet to the inner surface of said top sheet material comprises effecting said sticking in a region corresponding to the region of the vent holes.

14. A method of producing a disposable body warmer as set forth in claim 13, wherein in said step for sticking said leakage preventive sheets of unit length to the inner surface of said top sheet material, said leakage preventive sheets of unit length are stuck to the inner surface of said band-like top sheet material, with a predetermined space left between adjacent leakage preventive sheets.

15. A method of producing a disposable body warmer as set forth in any of claims 12-14, further comprising cutting said closing sheet material into unit lengths, and sticking the closing sheets of unit length to the outer surface of said top sheet material in regions each corresponding to the region of the vent holes.

16. A method of producing a disposable body warmer as set forth in claim 15, wherein in said sticking said closing sheets to the outer surface of said band-like top sheet material in regions each corresponding to the region of said vent holes, a predetermined space is left between adjacent closing sheets.

17. A method of producing a disposable body warmer as set forth in any of claims 12-14, wherein in said step for interposing the exothermic composition powder between said top sheet material and said back sheet material in a region corresponding to said leakage preventive sheet, said top sheet material and back sheet material are guided between a pair of seal rolls from above in a V-shaped path while predetermined amounts of exothermic composition powder are packed between the top sheet material and the back sheet material in regions corresponding to the inside leakage preventive sheets by a dispensing means.
